(19) United States
(12) Patent Application Publication
(10) Pub. No.: US 2020/0258094 A1
(43) Pub. Date: Aug. 13, 2020

(54) Rating Of An Environmental Health Impact Of A Product

(71) Applicant: MindClick Group, Inc., Bend, OR (US)

(72) Inventor: JoAnna Abrams, Bend, OR (US)

(73) Assignee: MindClick Group, Inc., Bend, OR (US)

(21) Appl. No.: 16/514,566

(22) Filed: Jul. 17, 2019

Related U.S. Application Data
(60) Provisional application No. 62/803,463, filed on Feb. 9, 2019.

(51) Int. Cl. G06Q 30/00

(52) U.S. Cl. CPC G06Q 30/018

(57) ABSTRACT

Rating of an environmental health impact of a product is disclosed herein. The method and system rate products in terms of sustainability and EHI and in comparison with alternative products. These ratings provide a numerical value from 0 to 200, and also a qualitative rating that reflects the product's EHI and sustainability performance in comparison with competitors within its product category.

### CROSS REFERENCE TO RELATED APPLICATION

The Present Application claims priority to U.S. Provisional Patent Application No. 62/803463, filed on Feb. 9, 2019, which is hereby incorporated by reference in its entirety.

### STATEMENT REGARDING FEDERALLY SPONSORED RESEARCH OR DEVELOPMENT

Not Applicable

### BACKGROUND OF THE INVENTION

### Field of the Invention

The present invention generally relates to supply chain data.

### Description of the Related Art

The prior art discusses product rating systems in various vertical markets, such as FICO, which nets out a borrowers risk rating based on a variety of financial metrics to produce a numerical score, and JD Power, which rates automobiles, automobile companies and another eight industries.

General definitions for terms utilized in the pertinent art are set forth below.

Metric is one of ‘Safer Chemicals’, ‘Responsible Resources’, or ‘Optimized Packaging’, but also all aspects of a product lifecycle, the key categories of supply chain sustainability solutions for hospitality, which is applicable to most other industries, for example included in hospitality are metrics for materials/ingredients, chemical, manufacturing-facilities, manufacturing-fair labor, packaging, distribution, user-health, user operations, and end of life/use.

EHI is environmental health impact, and supply chain sustainability is the measurement of suppliers and their products based on sustainability standards as determined by MindClick, and/or in collaboration with MindClick customers and stakeholders.

Attribute is a specific aspect of an EHI or supply chain sustainability measure of interest, such as “Latex Free” or “Recyclable”, part of an EHI profile or supply chain sustainability measure for a product used in evaluating the score and rating for it.

Product Category includes categories such as “Wound Care”, “Flooring” or “Respiratory Therapy”, groups of products focused on a particular purpose. Also a product family defined as a group of products which have like material/ingredient and chemical compositions and can be grouped together for the purposes of sustainability and EHI reporting.

Impact is how damaging or costly the commercial effects are of a negative attribute, or of value the commercial effects are to a positive attribute.

SC is safer chemicals (chemicals of high concern).

RR is responsible resources.

OP is optimized packaging.

Organizations are increasingly interested in the environmental health impacts and sustainability of the products they buy, and they need an efficient way to compare products from this perspective.

There are over 500 eco-labels and certifications on the market all attempting to report on the sustainability or EHI profile of products. Without regulation, purchasing decision makers struggle to understand and compare performance and suppliers struggle to report and validate performance. Both parties need a common ratings system whereby they can quickly determine and compare the sustainability/EHI profile of products.

### BRIEF SUMMARY OF THE INVENTION

The present invention provides a flexible and clear way to rate products in terms of sustainability and EHI and in comparison with alternative products. These ratings provide a numerical value from 0 to 200, and also a qualitative rating that reflects the product's EHI and sustainability performance in comparison with competitors within its product category. Alternatively, the ratings can be customized based on customer preferences, weights, etc.

The present invention gives each product a numerical score from 0-100 in healthcare and 0-200 in hospitality, as well as a qualitative and comparative rating. This rating, for example “Leader”, “Achiever”, or “Starter”, shows whether the product is among the best vs. its competitors, is good relative to competitors, or has only some positive EHI and sustainability attributes.

One aspect of the present invention is a non-transitory computer-readable medium that stores a program that causes a processor to perform functions to rate an environmental health impact of a product and sustainability performance of products and their manufacturers by executing the following steps: collecting a plurality of product attributes for a product at a product database; determining a plurality of relevant product attributes from the plurality of product attributes based on a plurality of attribute values, each of the plurality of attribute values for products in a specific category for a specific metric; calculating an impact weight for each of the plurality of product attributes; calculating a plurality of points for each positive product attribute of the plurality of relevant product attributes based a points formula; generating a score for the product; and generating a rating for the product.

Another aspect of the present invention is a method to rate an environmental health impact of a product and sustainability performance of a product and manufacturer. The method includes collecting a plurality of product attributes for a product at a product database. The method also includes determining a plurality of relevant product attributes from the plurality of product attributes based on a plurality of attribute values. Each of the plurality of attribute values for products in a specific category for a specific metric. The method also includes calculating an impact weight for each of the plurality of product attributes. The method also includes calculating a plurality of points for each positive product attribute of the plurality of relevant product attributes based a points formula. The method also includes generating a score for the product. The method also includes generating a rating for the product.

Having briefly described the present invention, the above and further objects, features and advantages thereof will be recognized by those skilled in the pertinent art from the following detailed description of the invention when taken in conjunction with the accompanying drawings.

### BRIEF DESCRIPTION OF THE SEVERAL VIEWS OF THE DRAWINGS

FIG. 1 is a flow chart of a method to rate an environmental health impact of a product and sustainability performance of a product and manufacturer.

FIG. 2 is a block diagram of an electronic device/server to rate an environmental health impact of a product and sustainability performance of a product and manufacturer.

FIG. 3 is a block diagram of a system to rate an environmental health impact of a product and sustainability performance of a product and manufacturer.

FIG. 4 is a block diagram of a method to generate a product attribute to rate an environmental health impact of a product and sustainability performance of a product and manufacturer.

### DETAILED DESCRIPTION OF THE INVENTION

The invention was created in response to specific needs in the hospitality and healthcare markets, where hotel chains and healthcare providers have launched initiatives to improve their impact on customer and community health. Purchasing staff and supply chain managers are not able to collect the necessary product information and analyze it such that they can inform their purchasing decisions in a timely and cost-effective manner. Few third-party sources exist for this data, and no source provides the simple-to-use, FICO-score-like ratings that would make purchasing decisions simple. The invention allows these purchasers to see both the product price and the EHI and sustainability rating quickly, and to compare alternative products based on EHI and sustainability rating, such that they can make quick purchasing decisions that support their environmental and sustainability initiatives.

The platform provides a web interface to inquire about the EHI and sustainability profile of any product and its manufacturers. The platform also provides integration with customer catalogs, data sets, purchasing tools, and analytical and reporting solutions. The platform also provides a programming interface for integration with third-party purchasing environments.

The system preferably includes a product database, product attributes and values and a rating algorithm.

The platform imports product attributes by gathering information about products from suppliers, needed for the analysis. Suppliers obtain this information from their suppliers, third-party testing, or in-house testing. The platform imports product families identified by suppliers based on shared material, ingredient and chemical characteristics enabling suppliers to associate groups of products for the purposes of streamlining reporting and analysis.

The platform determines relevant attributes based on the attribute values across all products in each category for each metric, which provides for exclusion of attributes from the scoring algorithm based on a consensus among suppliers that an attribute does not apply in a particular product category.

The platform preferably calculates impact weights for each attribute. Based on industry research, the impact of each attribute is weighted in the calculation. Each is assigned a weighting for severity, cost, and contact impact. Alternatively, the platform enables weights and rating to be customized by a user.

The platform calculates the points to be earned for each positive attribute value according to a points formula, which is based on metric, and attribute, the number of points available for a positive attribute value is calculated, to be used later in scoring based on the number of positive attributes for a particular product.

The platform scores each product according to a scoring formula based on each product's attribute values.

The platform rates each product according to a rating formula.

An input of supplier product catalog data, item numbers, product families and product categories into the platform generates an output of a numerical EHI and sustainability score.

An input of product attributes (these are the answers to questions about the products—Does it contain latex, or BPA, is it recyclable, etc. currently there are 37 attributes, but the number of attributes depends on the vertical (hospitality vs healthcare vs others in future), the results of research into the health or environmental impacts of product ingredients, and the evolution of product design and manufacturing techniques. Likely, the mix of attributes will constantly evolve as product ingredients found to have negative health effects are no longer used and new ingredients with unknown effects are added) into the platform generates an output of an EHI rating (e.g., leading, achiever, starter).

The points formula is PPA=(((100/TWAC)*TWAM)/RAM)*IW=Points per Positive Attribute (per Category and Metric), wherein:

TWAC=Total Weighted Attributes per Category=SUM(RAC*MW)

TWAM=Total Weighted Attributes per Metric

RAC=Relevant Attributes per Category

RAM=Relevant Attributes per Metric

MW=Metric Weight=1 [RR,OP], 2 [SC]

PPA=Points per Attribute

TRA=Total Relevant Attributes for the Category

DW=Documentation Weight=A factor described below that allows full credit when validated documentation exists, partial credit when un-validated documentation exists, and zero credit if not documentation has been provided.

AW=Attribute Weight=A per-attribute, per category weighting of the attribute, used to indicate attributes which are more important from an EHI perspective

MIW=Metric Impact Weight=, and

IW=Impact Weight per Metric and Category=SUM(AW*MIW).

A scoring formula is: For Each Metric, SUM(PPA**DW) for each positive attribute, wherein documentation weight is:

1) 1.0 if validated documentation has been provided for the product;

2) A factor between 0 and 1.0—documentation provided, but has not been validated. This is an adjustable parameter; for example, the settings might be 0.5 for the RR and OP metrics, and 0.75 for SC since a lack of documentation is or more concern in the Safe Chemicals case; and

3) 0—no supporting documentation provided.

A rating formula using scoring thresholds, for example, is the product rating is the first match from these criteria:

1) Leader—If score>=50 AND score>=70% of maximum score in the product category;

2) Achiever—If score>=30% of the maximum score in the product category; and

3) Starter—If score>0.

An alternative rating formula is a simple threshold score of ≥60 for leaders, ≥20 for achievers and ≥0 for starters.

Yet an alternative rating formula requires all attributes verified by a designated entity, and have a score of ≥60 for leaders, or ≥60 without verification for achievers and ≥0 for starters.

A points formula is: PPA=(((100/TWAC)*TWAM)/RAM)*IW=Points per Positive Attribute (per Category and Metric); wherein RAC=Relevant Attributes per Category; wherein RAM=Relevant Attributes per Metric; wherein MW=Metric Weight=1 [RR,OP], 2 [SC]; wherein PPA=Points per Attribute; wherein AW=Attribute Weight; wherein IW=Impact Weight per Metric and Category=SUM(AW*MIW); wherein TWAC=Total Weighted Attributes per Category=SUM(RAC*MW); and wherein TWAM=Total Weighted Attributes per Metric.

The various parameters vary by product category and metric to allow metric weights and impact weights to be customized with fine granularity.

The core of the calculation is “100/TWAC”, giving a raw value for the number of points granted for each positive product attribute, where TWAC is the number of consensus relevant attributes in a category multiplied by a metric-dependent weight. This allows attributes in a particular metric, such as safer chemicals (SC), to play a bigger role in the determination of the score if those attributes are determined to be of greater importance in the environmental health impact of a given product. For example, the presence or absence of lead in a product could be weighted to have a greater impact on the overall EHI score than the product's recyclability.

This raw points per attribute value is then multiplied by the ratio of TWAM/RAM, which is the total number of attributes per metric, weighted based on the metric weight for the attribute, divided by the number of relevant attributes per metric, un-weighted. This is done to further normalize the scoring across metrics.

Finally, the points per attribute is multiplied by the impact weight, which reduces the available points per attribute by varying fractions based on relative impact the attribute has within the metric. Calculated as the sum of the attribute weight (AW) multiplied by the metric impact weight, this factor allows greater flexibility based on the importance of the attribute as determined by consensus among suppliers or through industry standards or trade groups, and the impact an unfavorable value for the attribute might have on the environment in terms of cost, severity, and whether the product comes in contact with people.

One embodiment of the present invention is a non-transitory computer-readable medium that stores a program that causes a processor to perform functions to rate the EHI or sustainability performance of a product by executing the following steps: collecting a plurality of product attributes for a product at a product database; determining a plurality of relevant product attributes from the plurality of product attributes based on a plurality of attribute values, each of the plurality of attribute values for products in a specific category for a specific metric; calculating an impact weight for each of the plurality of product attributes; calculating a plurality of points for each positive product attribute of the plurality of relevant product attributes based a points formula; generating a score for the product; and generating a rating for the product.

The specific metric is preferably selected from the group consisting of safer chemicals, responsible resources, optimized packaging, or any of the following metric categories: materials/ingredients, chemicals, manufacturing-operations, manufacturing-fair labor, packaging, distribution, use phase-operations, use phase-user, and end of life. Those skilled in the pertinent art will recognize that other metrics may be utilized without departing from the scope and sprit of the present invention.

The specific category is preferably selected from the following, however those skilled in the pertinent art will recognize that other categories may be utilized without departing from the scope and sprit of the present invention:

ACCESS; ACUTE CARE BEDS; ADHESIVE DRAPES; ADVANCED WOUND CARE; AIRWAY CLEARANCE; ANCILLARY EQUIPMENT; ANESTHESIA MACHINES; ANESTHESIA MASKS AND CIRCUITS; ANESTHESIA NEEDLES; ANESTHESIA TRAYS; ANKLE PRODUCTS AND/OR SOFTGOODS; ANTI EMBOLISM STOCKINGS; ANTIMICROBIAL CATHETER DISC; ANTIMICROBIAL WOUND CLEANSER; ARTHROSCOPY; BABY CARE PRODUCTS; BARIATRIC MATTRESSES; BEDS; BEVERAGE; BIOLOGIC SURGICAL MESH; BIOPATCH; BIOPSY INSTRUMENTS AND NEEDLES; BIOSURGERY; BLOOD BANK; BLOOD CULTURE SYSTEMS; BLOOD GAS ANALYZERS; BLOOD GLUCOSE METERS; BLOOD PRESSURE CUFFS; BONE CEMENT; BONE CEMENT ACCESSORIES; BONE DENSITOMETRY; BOWEL MANAGEMENT SYSTEM; BREAST FEEDING PUMPS; BREAST IMPLANTS; BRUSHLESS SURGICAL HAND SCRUBS; CAPITAL EQUIP SOURCING AND PLANNING TOOLS; CARDIAC MONITORS; CARDIAC RHYTHM MANAGEMENT PRODUCTS & ACCESSORIES; CARDIAC/VASCULAR INTERVENTIONAL SYSTEMS; C-ARMS; CARTS AND SHELVING; CASTING; CENTRAL VENOUS CATHETERS; CHART PAPER; CHEMISTRY; CHEST DRAINAGE; CHG PREOPERATIVE SKIN PREP; CHILDREN'S INCENTIVES; CLEAN ROOM SUPPLIES; CLINICAL EQUIPMENT MAINTENANCE; COAGULATION; COFFEE AND TEA—GROUND; COMPRESSION APPARELS; COMPUTER SUPPLIES; CONDIMENTS—MUSTARD; CONTRAST MEDIA; CONVECTIVE AIR WARMING; COOKIES AND CRACKERS; CORONARY PRODUCTS & ACCESSORIES; CORONARY STENTS; CR EQUIPMENT; CRANIO-MAXILLOFACIAL (CMF); CRITICAL CARE RESPIRATORY; CT SCANNER SYSTEMS; CUSTOM PROCEDURE TRAYS; DESSERTS—GELATIN SINGLE SERVE; DESSERTS, REFRIGERATED GELATIN AND PUDDING; DIABETES CARE; DIAGNOSTIC PROCEDURE TRAYS; DIALYSIS; DIETARY KITS; DISPOSABLE INFUSION PUMPS; DISPOSABLE MANUAL RESUSCITATORS; DISPOSABLE OR ACCESSORIES; DISPOSABLE VAGINAL SPECULUM; DISPOSABLE WOUND PROTECTORS; DISTRIBUTION—DIAGNOSTIC IMAGING; DISTRIBUTION—FACILITIES MANAGEMENT; DISTRIBUTION—FOOD AND NUTRITION; DISTRIBUTION—LABORATORY; DISTRIBUTION—MEDICAL/SURGICAL; DISTRIBUTION—RADIOPHARMACEUTICALS; DOCUMENT MANAGEMENT; DRAINS; DURABLE MEDICAL EQUIPMENT; ECG ELECTRODES, CABLES, LEAD WIRES AND DEFIBRILLATOR PADS; EGGS, FURTHER PROCESSED AND SHELL; ELASTIC BANDAGES; ELECTROPHYSIOLOGY PRODUCTS; ELECTROSURGICAL EQUIPMENT; ELECTROSURGICAL PENCILS AND ACCESSORIES; ELECTROSURGICAL VESSEL SEALING; ENDOMECHANICALS; ENDOSCOPE CLEANERS; ENDOSCOPIC INSTRUMENTS; ENDOTRACHEAL TUBES; ENERGY; ENT INSTRUMENTS; ENTERAL FEEDING; ENVIRONMENTAL PROTECTION; EQUIPMENT RENTAL; ETO STERILIZATION; EXAM GLOVES; EXAM ROOM EQUIPMENT; EXAM ROOM PAPER PRODUCTS; EXTERNAL DEFIBRILLATORS; FACIAL PROTECTION; FALLS MANAGEMENT; FEEDING PUMPS; FETAL MONITORING BELTS; FISTULA AND WOUND MANAGEMENT; FLOOR CLEANING EQUIPMENT; FLUID WARMING; FOOD AND NUTRITION; FOOD SERVICE DISPOSABLES; FREIGHT MANAGEMENT; FURNITURE; GASTRIC BAND; GENERAL LAB EQUIPMENT; GENERAL RADIOGRAPHY EQUIPMENT; GENERIC INJECTABLES; GI LAB ACCESSORIES; GROUNDING PADS—DISPOSABLE; GROUNDING PADS—REUSABLE; GYNECARE; HAND ACCESS SURGICAL DEVICE; HAND HYGIENE; HEALTHCARE AUTOMATED TECHNOLOGY; HEART VALVES; HEMATOLOGY; HEMODYNAMIC (HD) & ELECTROPHYSIOLOGY (EP) MONITORS; HERNIA REPAIR & FIXATION; HISTOLOGY; HOLTER AND EVENT MONITORS; HOT AND COLD PACKS; HOUSEKEEPING CHEMICALS; IABP SYSTEMS; IMAGE GUIDANCE SYSTEMS; IMMUNOCHEMISTRY; IMMUNOHISTOCHEMISTRY; IMPLANTS—CARDIOVASCULAR; IMPLANTS—HIPS; IMPLANTS—HIPS AND KNEES; IMPLANTS—KNEES; IMPLANTS—MAMMARY; IMPLANTS—NEUROSURGICAL; IMPLANTS—SHOULDER; IMPLANTS—SHOULDERS; IMPLANTS—SPINAL; INCONTINENCE PRODUCTS; INCUBATORS AND WARMERS; INFANT CARE EQUIPMENT & PHOTOTHERAPY; INFANT DIAPERS; INFANT FORMULA; INFANT HEARING SCREENING; INFUSION THERAPY KITS; INJECTABLE CONTRAST MEDIA; INSTRUMENT CARE PRODUCTS; INSTRUMENTS; INTERVENTIONAL UROLOGY PRODUCTS; INTRAUTERINE PRESSURE CATHETERS; INTRAVASCULAR PATIENT TEMPERATURE MANAGEMENT; ITI NPWT MEDICAL DEVICES; IV CATHETERS; IV PUMPS TUBING AND SOLUTIONS; IV SETS AND SOLUTIONS; JUICE—PORTION CONTROL AND BULK; LABORATORY MICROSCOPES; LACTATION CARE; LAPAROSCOPIC IRRIGATION; LARYNGOSCOPES; LEVEL OF SEDATION MONITORS; LOCALIZED COLD THERAPY; LOW TEMPERATURE STERILIZERS; MANUAL MICROBIOLOGY; MEDICAL DEVICE REPROCESSING; MEDICAL EDUCATION AND SOFTWARE; MEDICAL GASES; MEDICAL LABELS; MEDICAL NUTRITIONALS; MEDICAL RESEARCH; MEDICAL TAPES; MEDICATION DELIVERY RESPIRATORY; MESH; MICROFIBER PRODUCTS, MATS AND ACCESSORIES; MINOR PROCEDURE TRAYS; MOLECULAR TECHNOLOGY; MONITORING ELECTRODES; MRI COMPATIBLE INFUSION PUMPS; MRI EQUIPMENT; NASOGASTRIC TUBES; NEEDLES AND SYRINGES; NEONATAL SPECIALTY PRODUCTS; NEURO INTERVENTIONAL PRODUCTS & ACCESSORIES; NEURO POWER TOOLS AND ACCESSORIES; NEURODIAGNOSTIC EQUIPMENT; NEUROSURGICAL PRODUCTS; NGX; NON-INVASIVE CARDIOLOGY EQUIPMENT; NON-STERILE KITS; NON-STERILE PHLEBOTOMY AND DONOR SCREENING KITS; NUCLEAR MEDICINE EQUIPMENT; NURSE CALL SYSTEMS; OB PRODUCTS—INFANT ID; OB PRODUCTS—LABOR & DELIVERY; OB PRODUCTS—NEWBORN CARE; OB SPECIALTY PRODUCTS; OFFICE PRODUCTS; ONCOLOGY; OPHTHALMIC PRODUCTS; OR ACCESSORIES; OR CONSOLES AND SINKS; OR LIGHTS, COLUMNS AND BOOMS; OR SPONGES AND TOWELS; OR TABLES; OR TURNOVER KITS; ORAL AIRWAYS; ORAL CARE; ORAL DISPENSERS; ORTHO POWER TOOLS AND ACCESSORIES; ORTHOBIOLOGICS; OSTOMY PRODUCTS; OTOSCOPES/OPHTHALMOSCOPES; PACS; PAIN MANAGEMENT; PAIN PUMPS; PATIENT CARE PLASTICS AND REUSABLES; PATIENT CLEANSING PRODUCTS; PATIENT FOOTWEAR; PATIENT ID BANDS; PATIENT LIFTS; PATIENT MONITORING; PATIENT POSITIONERS; PATIENT WARMING; PEG TUBES; PELVIC RECONSTRUCTION AND INCONTINENCE; PERFUSION EQUIPMENT AND DISPOSABLES; PERFUSION PRODUCTS; PERIPHERAL VASCULAR PRODUCTS & ACCESSORIES; PERSONAL CARE PRODUCTS; PERSONAL PROTECTION EQUIPMENT; PET/CT SYSTEMS; PHARMACEUTICAL COMPOUNDING; PHARMACEUTICALS; PHLEBOTOMY; PILL CUTTERS; PLASMA; PNEUMATIC COMPRESSION DEVICES; PNEUMATIC TOURNIQUET CUFF SYSTEMS; POINT-OF-CARE TESTING; POLY CAN LINERS; POLYMERIC MEMBRANE DRESSING; PORTABLE SUCTION EQUIPMENT; POST MORTEM BAGS; POST OP AUTOTRANSFUSION; POST-OPERATIVE BRAS; PREFILLED SYRINGES; PREOPERATIVE SKIN PREP; PRESSURE-RELIEVING HEEL PROTECTION; PULMONARY FUNCTION EQUIPMENT; PULSE OXIMETRY; PVP-I SURGICAL SKIN PREP; R/F EQUIPMENT; RADIATION TREATMENT PLANNING; RADIOPHARM—HIGH ENERGY; RADIOPHARM—LOW ENERGY; RAPID TEST KITS; REGIONAL ANESTHESIA; REGIONAL ANESTHESIA TRAYS OR NEEDLES; REHABILITATION PRODUCTS; RESTRAINTS AND FALL PREVENTION PRODUCTS; REUSABLE HANDHELD SURGICAL INSTRUMENTS; REUSABLE TEXTILES; RIGID STERILIZATION CONTAINERS; ROUTINE RESPIRATORY; SAFETY HUBER NEEDLES; SAFETY HYPODERMIC PRODUCTS; SAFETY NEEDLES AND SYRINGES; SANITARY PAPER; SCALES AND ACCESSORIES; SECUREMENT DEVICES; SHARPS CONTAINERS; SHELF STABLE JUICES; SINGLE INCISION SURGICAL DEVICES; SKIN CARE; SKIN INTEGRITY—PRIMARY, SECONDARY WOUND CARE DRESSINGS AND WOUND DEBRIDEMENT; SKIN INTEGRITY—SKIN CLEANSERS, BARRIERS AND LOTIONS; SKIN PREP AND SOLUTIONS; SMALL JOINTS; SNACKS; SPECIALTY BAGS; SPECIALTY INFUSION PUMPS; SPECIALTY STERILIZATION SERVICES; SPECIMEN COLLECTION CONTAINERS; SPHYGMOMANOMETERS; SPORTS MEDICINE BRACING; STANDARD NEEDLES AND SYRINGES; STATIC AIR OVERLAYS; STEAM STERILIZERS; STERILITY ASSURANCE PRODUCTS; STERILIZATION AND DECONTAMINATION; STERILIZATION PACKAGING; STERILIZATION SOLUTIONS; STERILIZATION WRAP; STRETCHERS; STUTURE E PACK; SUCTION CANISTERS; SUPRAGLOTTIC AIRWAYS; SURFACE DISINFECTING WIPES; SURGICAL AND ISOLATION MASKS; SURGICAL BLADES AND SCALPELS; SURGICAL CLIPPERS PRODUCTS; SURGICAL COUNTING AND DETECTION; SURGICAL DEVICE DECONTAMINATION; SURGICAL EQUIPMENT COVERS; SURGICAL GLOVES; SURGICAL HEADLIGHTS; SURGICAL INSTRUMENTS; SURGICAL MESH PRODUCTS; SURGICAL MICROSCOPES; SURGICAL NONWOVENS; SURGICAL PREP KITS; SURGICAL SCRUB BRUSHES; SURGICAL SKIN PREP; SUTURE; SUTURE E PACK; SYNTHETIC SURGICAL MESH; TEMPERATURE MONITORING PROBES; TEMPORAL THERMOMETERS; TEXTILES AND APPARELS; THERAPEUTIC BEDS AND SURFACES; THERMODILUTION CATHETERS; THERMOMETRY; TOPICAL SKIN ADHESIVE; TOURNIQUET CUFFS; TOYS STICKERS AND GAMES; TRACHEOSTOMY TUBES; TRACTION; TRADITIONAL SURGICAL HAND SCRUB; TRADITIONAL WOUND CARE; TRANSPARENT DRESSINGS; TRAUMA; TRAYS; TROCARS; TSA; ULTRASONIC CUTTING; ULTRASOUND EQUIPMENT; UNCLASSIFIED; URINALYSIS; URINARY CATHETERS AND DEVICES; UROLOGY IMAGING SYSTEMS; VASCULAR ACCESS PRODUCTS; VASCULAR CLOSURE DEVICES; VASCULAR GRAFTS; VASCULAR IMAGING SYSTEM; VEGETARIAN PRODUCTS; VENTILATORS; WARMING CABINETS; WASTE FLUID MANAGEMENT; WOUND DRAINAGE; WOUND LAVAGE; WOUND PROTECTION & RETRACTION DEVICES; YOGURTS—GREEK; and YOGURTS—REFRIGERATED. Specifically for hospitality categories there are: furniture, fixture and equipment (flooring, case goods, lighting, fabrics, wall coverings, seating, art & mirrors, equipment, beds, drapery, etc.) and building materials.

An operating system controls the execution of other computer programs, running of the PSO platform, and provides scheduling, input-output control, file and data management, memory management, and communication control and related services. The operating system may be, for example Windows (available from Microsoft, Corp. of Redmond, Wash.), LINUX or other UNIX variants (available from Red Hat of Raleigh, N.C. and various other vendors), Android and variants thereof (available from Google, Inc. of Mountain View, Calif.), Apple OS X, iOs and variants thereof (available from Apple, Inc. of Cupertino, Calif.), or the like.

The method described in connection with the embodiments disclosed herein is preferably embodied directly in hardware, in a software module executed by a processor, or in a combination of the two. A software module preferably resides in flash memory, ROM memory, EPROM memory, EEPROM memory, RAM memory, registers, a hard disk, a removable disk, a CD-ROM, or any other form of storage medium known in the art. An exemplary storage medium is preferably coupled to the processor, so that the processor reads information from, and writes information to, the storage medium. In the alternative, the storage medium is integral to the processor. In additional embodiments, the processor and the storage medium reside in an Application Specific Integrated Circuit (ASIC). In additional embodiments, the processor and the storage medium reside as discrete components in a computing device. In additional embodiments, the events and/or actions of a method reside as one or any combination or set of codes and/or instructions on a machine-readable medium and/or computer-readable medium, which are incorporated into a computer software program.

In additional embodiments, the functions described are implemented in hardware, software, firmware, or any combination thereof. If implemented in software, the functions are stored or transmitted as one or more instructions or code on a computer-readable medium. Computer-readable media includes both computer storage media and communication media including any medium that facilitates transfer of a computer program from one place to another. A storage medium is any available media that is accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures, and that can be accessed by a computer. Also, any connection is termed a computer-readable medium. For example, if software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. “Disk” and “disc”, as used herein, include compact disc (CD), laser disc, optical disc, digital versatile disc (DVD), floppy disk and BLU-RAY disc where disks usually reproduce data magnetically, while discs usually reproduce data optically with lasers. Combinations of the above should also be included within the scope of computer-readable medium.

A computer program code for carrying out operations of the Present Invention is preferably written in an object oriented, scripted or unscripted programming language such as C++, C#, SQL, Java, Python, Javascript, Typescript, PHP, Ruby, or the like.

Each of the interface descriptions preferably discloses use of at least one communication protocol to establish handshaking or bi-directional communications. These protocols preferably include but are not limited to XML, HTTP, TCP/IP, Serial, UDP, FTP, Web Services, WAP, SMTP, SMPP, DTS, Stored Procedures, Import/Export, Global Positioning Triangulation, IM, SMS, MMS, GPRS and Flash. The databases used with the system preferably include but are not limited to MSSQL, Access, My SQL, Oracle, DB2, Open Source DBs and others. Operating system used with the system preferably include Microsoft 2010, XP, Vista, 200o Server, 2003 Server, 2008 Server, Windows Mobile, Linux, Android, Unix, I series, AS 400 and Apple OS.

The underlying protocol at a server, is preferably Internet Protocol Suite (Transfer Control Protocol/Internet Protocol (“TCP/IP”)), and the transmission protocol to receive a file is preferably a file transfer protocol (“FTP”), Hypertext Transfer Protocol (“HTTP”), Secure Hypertext Transfer Protocol (“HTTPS”), or other similar protocols. The protocol at the server is preferably HTTPS.

Components of a server includes a CPU component, a graphics component, memory, non-removable storage, removable storage, Network Interface, including one or more connections to a fixed network, and SQL database(s). Included in the memory, is an operating system, a SQL server or other database engine, and computer programs/software.

### Product Attributes

Suppliers to group their individual items into product families based on the material composition (raw materials, chemicals, construction) of the items. This is to reduce survey fatigue for the supplier given that the responses to each of the product attribute questions will be the same across items in a product family. All audit-approved attributes and scores for a product family are then applied to each item within that product family.

### Sustainable Raw Materials (30 points)

This metric takes the highest response for any of the available sustainable raw materials (ex. If a supplier listed R&D underway for 1 material and the rest were non-existent, that product would earn 7.5 points (“pts”). If R&D is underway for multiple materials, the product still earns 7.5 pts).

1—Does not contain sustainable raw materials=0 pts

2—Not commercially feasible=0 pts (if none of the suppliers in the product category can include any sustainable raw materials, then the metric should be removed from that category)

3—R&D underway=7.5 pts

4—Contains sustainable raw materials
a. Sum of all sustainable raw materials is >0 but <10=15 pts
b. Sum of all sustainable raw materials is >=10 but <30=18 pts
c. Sum of all sustainable raw materials is >=30 but <50=22.5 pts
d. Sum of all sustainable raw materials is >=50=30 pts

Example—One product family has R&D underway around Sustainably Harvested materials, contains 25% pre-consumer recycled content and 6% post-consumer recycled content. That product family would earn 22.5 pts because 31% (25% pre+6% post) of the entire product family is made of sustainable materials.

### Chemicals of Concern (25 pts)

1—Have not addressed CoCs=0 pts

2—Requested chemical information from suppliers=6.25 pts

3—Evaluating CoCs in the product line=12.5 pts

4—In compliance with CoC lists=18.75 pts

5—3^{rd} party testing/certifications confirm compliance=25 pts

### Packaging (25 pts)

Sustainable Raw Materials (7.5 pts)—This metric takes the highest response of any of the available sustainable raw materials. If a sustainable raw material exists in the product's packaging, then a follow-up asks about the percentage of that material, however this is not factored into the scoring.
1—Not existent at this time=0 pts
2—Not existent because not commercially feasible=0 pts
3—R&D/testing underway=3.75 pts
4—Offered in the product line=7.5 pts

Packaging Recyclability/Reusability (7.5 pts)—This metric looks at the end of life options of BOTH interior and exterior packaging. The two are summed together to get the total score for this section.
1—Not recyclable/reusable=0 pts
2—R&D/testing underway=1.25 pts
3—Partially recyclable/reusable=2.5 pts
4—100% recyclable/reusable=3.75 pts

### Optimization/Reduction (10 pts)

1-Not existent=0 pts

2—Not commercially feasible=0 pts

3—R&D/testing underway=6.67 pts

4—Offered in this product line=10 pts

Distribution (15 pts)—For this metric, we first ask what aspect of distribution they are responsible for. If they say they are responsible for any aspect of their transportation, they are shown a question asking about their use of SmartWay/equivalent. If they are not responsible for any aspect, then they are automatically given full credit.
1—Not currently using SmartWay/equivalent methods=0 pts
2—Currently evaluating the use of SmartWay/equivalent=7.5 pts
3—SmartWay/equivalent is being used in distribution efforts=15 pts

Note—For Marriott, MC auditors give full credit for all suppliers not in the Bedding category, because Marriott handles the final distribution of these products and they use SmartWay. This is unique to Marriott and will not be done across other customers (Virgin, Hilton, etc).

Guest Health (10 pts)—This metric takes the highest response of any of the available guest health attributes (contributing to Reduced Toxins or Improved Indoor Air Quality).
1—Not existent=0 pts
2—Not commercially feasible=0 pts
3—R&D/testing underway=5 pts
4—Offered in this product line=10 pts

Note—If a supplier receives an audited score of a 4 or 5 on the chemicals question, then they should automatically receive an audited value of a 4 for Reduced Toxins.

The metrics are continually reviewed (Reduced Toxins and IAQ) as other health benefits become more well known/documented in the industry (noise pollution, type of lighting, etc) (review WELL Building Standard).

Hotel Impact (15 pts)—This metric assesses a product's ability to contribute to reduced energy, water, and waste production at hotels. This metric will average the scores across all three (energy, water, and waste) to get the score for the metric. IF a supplier responded that contributing to reduced energy or water is Not Applicable (1), then those scores are not factored into the score (all products can contribute to reduced waste at hotels, and therefore this metric is never excluded).
1—Not applicable (0 pts)
2—Not existent (0 pts)
3—Not commercial feasible (0 pts)
4—R&D/testing underway (7.5 pts)
5—Offered in this product line (15 pts)

Example—A supplier listed that it was not applicable for their product to contribute to reduced water (1), and earned credit for R&D underway to contributed to reduced energy (4) and reducing waste was offered in the product line (5). The reduced water score of 0 is not factored into the scoring, and the reducing water score (7.5 pts) and reducing waste (15 pts) scores are averaged to give the final score 11.25 pts for the product.

Note—If a supplier receives an audited score of 3 or 4 in the Packaging Recyclability/Reusability section for either interior or exterior packaging, or if they receive an audited score of a 4 for any End of Life (product) attributes, then they should automatically receive an audited value of a 5 for reducing Waste at hotels.

End of Life (25 pts)—This metric takes the highest response of any of the available end of life solutions. If all suppliers in the category respond not existent or not commercially feasible, then this metric should be removed from that category.
1—Not existent=0 pts
2—Not commercially feasible=0 pts
3—R&D/testing underway=12.5 pts
4—Offered in this product line=25 pts

### Facility Attributes

The following denotes how a facility's environmental and social scores are calculated. The calculation of a product family's environmental and social scores is discussed at the end of this section.

Essentially, each value in the facility section is calculated by the following formula: (numerical value of response)/(highest numerical value possible)*(maximum pts available in the metric)

So for example, if a directly controlled facility received credit for having completed a footprint in waste, that value would be:

(3/5)*25=0.6*25=15 pts.

Environmental (25 pts)—This metric averages the individual scores that a facility receives for Energy, Water, Waste, Carbon, and EMS.

*Note—If a supplier indicates that Water is only used for administrative purposes (restrooms/kitchens), then it is not factored into that facilities environmental score.

### Directly Controlled Facilities—Energy, Water, Waste, Carbon

1—No data=5 pts

2—Footprint started=10 pts

3—Footprint completed=15 pts

4—Footprint completed+reduction targets set=20 pts

5—Footprint completed+reductions achieved=25 pts

### Non-Directly Controlled Facilities—Energy, Water, Waste, Carbon

1—No data=3.57 pts

2—In process of requesting data=7.14 pts

3—Data requested=10.71 pts

4—Footprint started=14.29 pts

5—Footprint completed=17.86 pts

6—Footprint completed+reduction targets set=21.43 pts

7—Footprint completed+reductions achieved=25 pts

### DC Facility—EMS

1—No EMS=6.25 pts

2—EMS under development=12.5 pts

3—EMS implemented and testing=18.75 pts

4—EMS in place and tracking compliance=25 pts

### NDC Facility—EMS

1—No EMS required=5 pts

2—In process of requesting an EMS=10 pts

3—EMS requested=15 pts

4—EMS implemented and testing=20 pts

5—EMS in place and tracking compliance=25 pts

Example—Facility A is a DC facility and earned a 3 for energy, 4 for water, 2 for waste, 5 for carbon, and a 3 for EMS. That facility's environmental score would be:

(15+20+10+25+18.75)/5=17.75

Social (30 pts)—This metric averages the individual scores that a facility receives for Forced Labor, Discrimination, Child Labor, Freedom of Association, and Compliance with Environmental Law.

### DC Facility

1—No policy=6 pts

2—Policy implemented=12 pts

3—Policy+process for documenting complaints=18 pts

4—Policy+self-audits=24 pts

5—Policy+3^{rd} party audits=30 pts

### NDC Facility

1—No policy=5 pts

2—Policy requested=10 pts

3—Policy implemented=15 pts

4—Process for documenting complaints=20 pts

5—Policy+self-audits=25 pts

6—Policy+3^{rd} party audits=30 pts

Example—Facility A is a DC facility and earned a 3 for forced labor, 4 for discrimination, 4 for child labor, 5 for freedom of association, and 2 for compliance with environmental law. That facility's social score would be:

(18+24+24+30+12)/5=21.6

Product Family Env/Social Calculation—In order to calculate the environmental and social scores of a product family, we take a weighted average (based on the number of products made in that facility) of the score of each facility used to manufacture that product for the hotel. So if Facility A manufactured 800 units of Product Family 1 and received 20 pts in the social section, and Facility B manufactured 200 units of Product Family 1 and received 30 pts in the social section, then the calculation of Product Family 1's social score is as follows: (20*(800/1000))+(30*(200/1000))=16+6=22 pts.

### Final Rounding/Summation

The final values of each metric are rounded to (total available points in that metric)/20. For example, the social section is rounded to the nearest 30/20, or 1.5.

All of the metric scores are then added together and rounded to the nearest 10 to get the final overall score of that product family.

If a supplier has performed at the Starter level in the social section and has an overall score of a Leader, we automatically demote the Leader to an Achiever score (150 pts).

### Special Case—Fabricators

Suppliers that we have indicated as fabricators and therefore are not responsible for the sourcing of materials are not shown the questions related to sustainable raw materials, chemicals of concern, guest health, and end of life. Therefore, they can only earn a maximum of 110 points, and their ratings breakdown is: Less than 55 pts=Starter, 55-89 pts=Achiever, 90 pts or more=Leader.

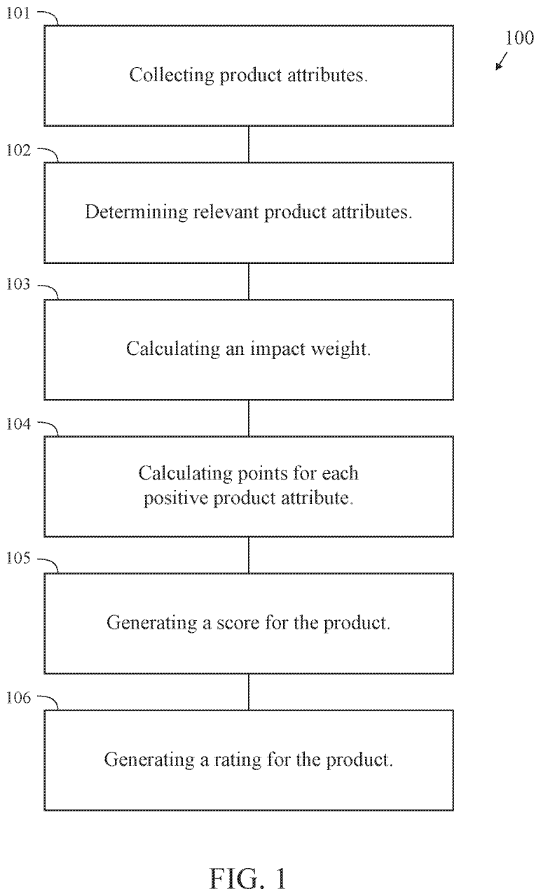

FIG. 1 is a flow chart of a method 100 to rate an environmental health impact of a product and sustainability performance of a product and manufacturer. At block 101, product attributes are collected for a product at a product database. At block 102, relevant product attributes are determined from the product attributes based on multiple attribute values. Each of attribute values is for products in a specific category for a specific metric. At block 103, an impact weight is calculated for each of the product attributes. At block 104, points for each positive product attribute of the relevant product attributes are calculated based a points formula. At block 105, a score for the product is generated. At block 106, a rating for the product is generated.

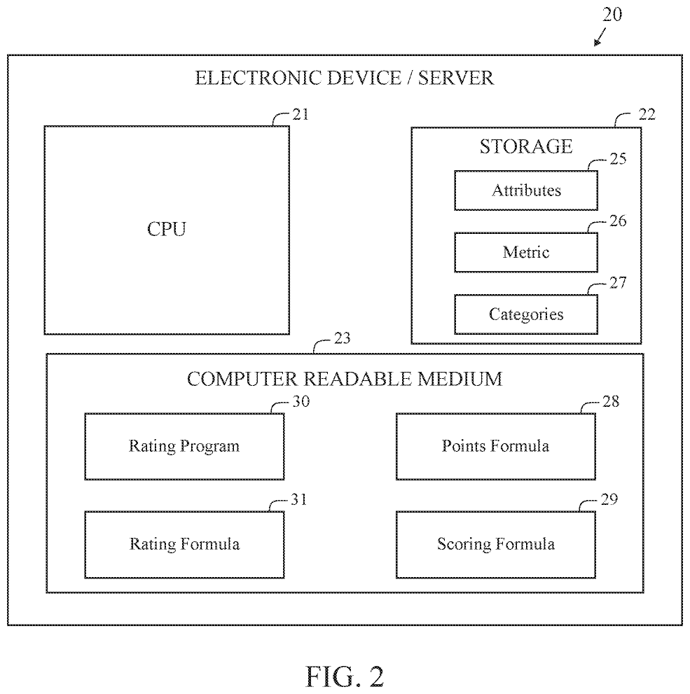

FIG. 2 is a block diagram of an electronic device/server 20 to rate an environmental health impact of a product and sustainability performance of a product and manufacturer. The server 20 comprises a CPU 21, a storage 22 and a computer readable medium 23. The storage 22 comprises attributes 25, a metric 26 and categories 27. The computer readable medium 23 comprises a points formula 28, a scoring formula 29, a rating program 30 and a rating formula 31.

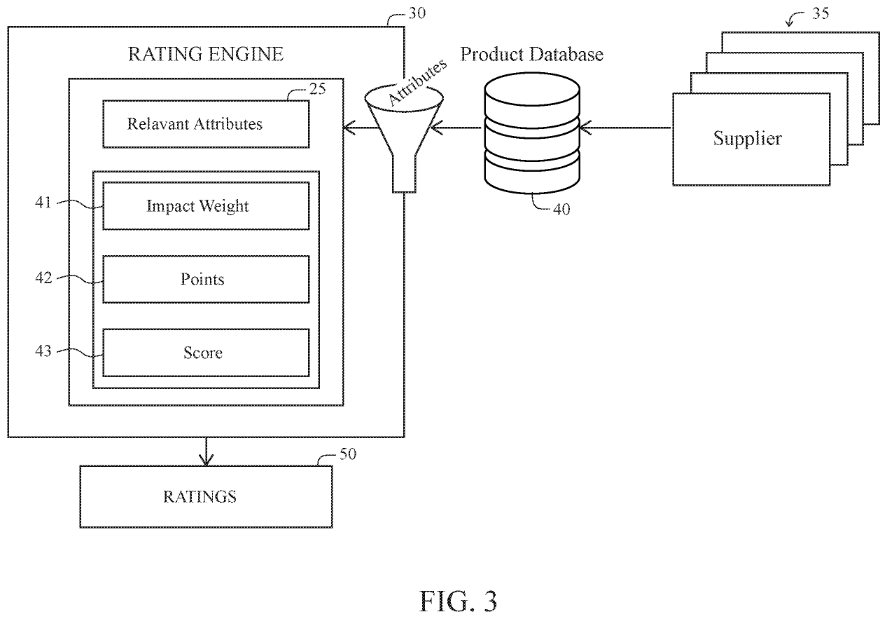

FIG. 3 is a block diagram of a system to rate an environmental health impact of a product and sustainability performance of a product and manufacturer. A rating engine 30 comprises relevant attributes 25, an impact weight 41, points 42 and a score 43. A supplier 35 accesses a product database 40 which provides attributes to the rating engine 30 which generates ratings 50 for products.

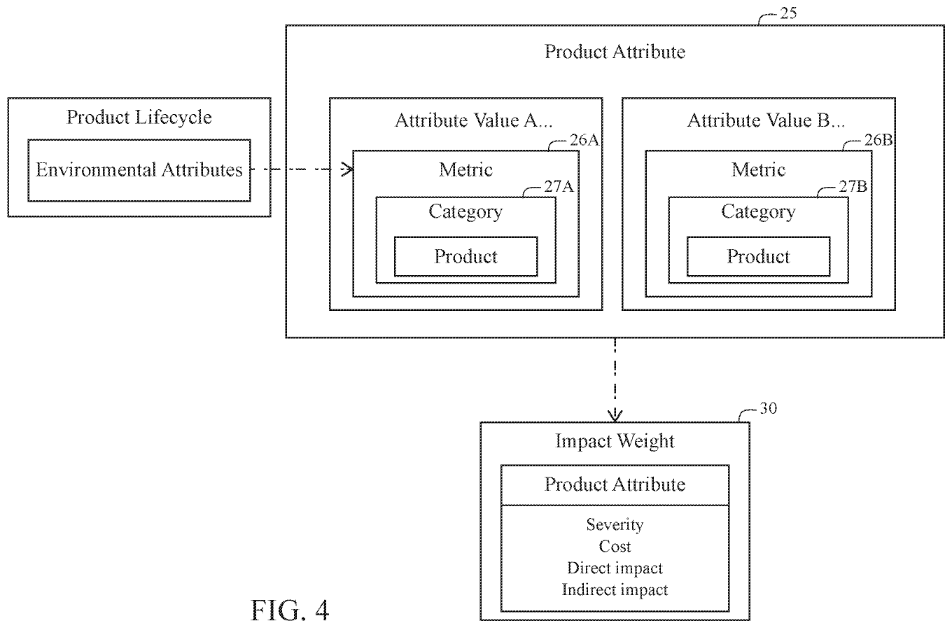

FIG. 4 is a block diagram of a method to generate a product attribute to rate an environmental health impact of a product and sustainability performance of a product and manufacturer. A product attribute 25 comprises a metric 26A and a category 27A for an attribute value A, and a metric 26B and a category 27B for an attribute value B. The impact weight 30 for the product attribute comprises severity, cost, direct impact and indirect impact.

From the foregoing it is believed that those skilled in the pertinent art will recognize the meritorious advancement of this invention and will readily understand that while the present invention has been described in association with a preferred embodiment thereof, and other embodiments illustrated in the accompanying drawings, numerous changes modification and substitutions of equivalents may be made therein without departing from the spirit and scope of this invention which is intended to be unlimited by the foregoing except as may appear in the following appended claim. Therefore, the embodiments of the invention in which an exclusive property or privilege is claimed are defined in the following appended claims.

I claim as my invention the following:

1. A non-transitory computer-readable medium that stores a program that causes a processor to perform functions to rate an environmental health impact of a product by executing the following steps:
collecting a plurality of product attributes for a product at a product database;
determining a plurality of relevant product attributes from the plurality of product attributes based on a plurality of attribute values, each of the plurality of attribute values for products in a specific category for a specific metric;
calculating an impact weight for each of the plurality of product attributes;
calculating a plurality of points for each positive product attribute of the plurality of relevant product attributes based a points formula;
generating a score for the product; and
generating a rating for the product.

2. The non-transitory computer readable medium according to claim 1 wherein the specific metric is selected from environmental attributes throughout the lifecycle of a product.

3. The non-transitory computer readable medium according to claim 1 wherein the rating ranges from 0 to 200.

4. The non-transitory computer readable medium according to claim 1 wherein calculating an impact weight for each of the plurality of product attributes is based on severity, cost, direct impact and indirect impact.

5. The non-transitory computer readable medium according to claim 1 wherein the specific category is selected from the group consisting of wound care and respiratory therapy.

6. The non-transitory computer readable medium according to claim 1 wherein the points formula is
PPA=(((100/TWAC)*TWAM)/RAM)*IW=Points per Positive Attribute (per Category and Metric);
wherein RAC=Relevant Attributes per Category;
wherein RAM=Relevant Attributes per Metric;
wherein MW=Metric Weight=1 [RR,OP], 2 [SC];
wherein PPA=Points per Attribute;
wherein IW=Impact Weight per Metric and Category=SUM(QW*MIW);
wherein TWAC=Total Weighted Attributes per Category=SUM(RAC*MW); and
wherein TWAM=Total Weighted Attributes per Metric.

7. The non-transitory computer readable medium according to claim 1 wherein the scoring formula is
SUM(PPA**DW) for each positive attribute;
wherein DW=Documentation Weight=A factor described below that allows full credit when validated documentation exists, partial credit when un-validated documentation exists, and zero credit if not documentation has been provided.

8. The non-transitory computer readable medium according to claim 1 wherein the rating formula is the first match from these criteria:
Leader—If score >=50 AND score >=70% of maximum score in the product category;
Achiever—If score >=30% of the maximum score in the product category; and
Starter—If score >0.

9. The non-transitory computer readable medium according to claim 1 wherein collecting a plurality of product attributes for a product at a product database comprises collecting information for products from a plurality of suppliers.

10. The non-transitory computer readable medium according to claim 1 wherein determining a plurality of relevant product attributes comprises excluding a plurality of attributes from the scoring algorithm based on a consensus among a plurality of suppliers that an attribute does not apply in a particular product category.

11. A method to rate an environmental health impact of a product, the method comprising:
collecting a plurality of product attributes for a product at a product database;
determining a plurality of relevant product attributes from the plurality of product attributes based on a plurality of attribute values, each of the plurality of attribute values for products in a specific category for a specific metric;
calculating an impact weight for each of the plurality of product attributes;
calculating a plurality of points for each positive product attribute of the plurality of relevant product attributes based a points formula;
generating a score for the product; and
generating a rating for the product.

12. The method according to claim 11 wherein the specific metric is selected from environmental attributes throughout the lifecycle of a product.

13. The method according to claim 11 wherein the rating ranges from 0 to 200.

14. The method according to claim 11 wherein calculating an impact weight for each of the plurality of product attributes is based on severity, cost, direct impact and indirect impact.

15. The method according to claim 11 wherein the specific category is selected from the group consisting of wound care and respiratory therapy.

16. The method according to claim 11 wherein the points formula is
PPA=(((100/TWAC)*TWAM)/RAM)*IW=Points per Positive Attribute (per Category and Metric);
wherein RAC=Relevant Attributes per Category;
wherein RAM=Relevant Attributes per Metric;
wherein MW=Metric Weight=1 [RR,OP], 2 [SC];
wherein PPA=Points per Attribute;
wherein IW=Impact Weight per Metric and Category=SUM(QW*MIW);
wherein TWAC=Total Weighted Attributes per Category=SUM(RAC*MW); and
wherein TWAM=Total Weighted Attributes per Metric.

17. The method according to claim 11 wherein the scoring formula is SUM(PPA**DW) for each positive attribute;
wherein DW=Documentation Weight=A factor described below that allows full credit when validated documentation exists, partial credit when un-validated documentation exists, and zero credit if not documentation has been provided.

18. The method according to claim 11 wherein the rating formula is the first match from these criteria:
Leader—If score >=50 AND score >=70% of maximum score in the product category;
Achiever—If score >=30% of the maximum score in the product category; and
Starter—If score >0.

19. The non-transitory computer readable medium according to claim 1 wherein collecting a plurality of product attributes for a product at a product database comprises collecting information for products from a plurality of suppliers.

20. The method according to claim 11 wherein determining a plurality of relevant product attributes comprises excluding a plurality of attributes from the scoring algorithm based on a consensus among a plurality of suppliers that an attribute does not apply in a particular product category.
